(19) United States
(12) Patent Application Publication
(10) Pub. No.: US 2011/0227911 A1
(43) Pub. Date: Sep. 22, 2011

(54) IMAGE DISPLAY DEVICE AND METHOD FOR OPERATING THE SAME

(75) Inventors: Youngsun JOO, Seoul (KR); Uniyoung Kim, Seoul (KR)

(73) Assignee: LG Electronics Inc.

(21) Appl. No.: 12/959,706

(22) Filed: Dec. 3, 2010

(30) Foreign Application Priority Data
Mar. 22, 2010 (KR) 10-2010-0025402
Mar. 25, 2010 (KR) 10-2010-0026932

(51) Int. Cl. G06T 15/00

(52) U.S. Cl. 345/419

(57) ABSTRACT

A method may be provided for operating an image display device capable of three-dimensionally displaying an object. The method may include producing a main image, providing a first subtitle On Screen Display (OSD) object for displaying a first subtitle of the main image, and providing a second subtitle OSD object for displaying a second subtitle of the main image. The second subtitle OSD object may have a different depth value from the first subtitle OSD object. The method may also include displaying the first subtitle OSD object and the second subtitle OSD object.

### CROSS-REFERENCE TO RELATED APPLICATIONS

This application claims benefit and priority from Korean Application No. 10-2010-0025402, filed Mar. 22, 2010 and Korean Application No. 10-2010-0026932, filed Mar. 25, 2010, the subject matters of which are incorporated herein by reference.

### BACKGROUND

1. Field

Embodiments of the present invention may relate to an image display device and/or a method for operating an image display device. More particularly, embodiments of the present invention may relate to an image display device and a method for operating an image display device that may display a plurality of objects in multiple layers and may control perceived depths (or depth effects) of the objects.

2. Background

An image display device is an apparatus to display an image that may be viewed by the user. The user may view broadcasts through the image display device. The image display device may display a broadcast that the user has selected from among broadcasts transmitted by a broadcast station. Broadcasting is transitioning from analog broadcasting to digital broadcasting throughout the world.

Digital broadcasting may transmit digital video and audio signals. Compared to analog broadcasting, digital broadcasting may be more robust to external noise, causing less data loss. Digital broadcasting may also be advantageous in error correction and may provide clear high-resolution images or screens. Digital broadcasting may also provide bi-directional services, unlike analog broadcasting.

Three-dimensional (3D) image technology may gradually become universal and practical not only in computer graphics but also in various other environments and technical fields. Digital broadcasting may also transmit 3D images and apparatuses for reproducing 3D images.

### BRIEF DESCRIPTION OF THE DRAWINGS

Arrangements and embodiments may be described in detail with reference to the following drawings in which like reference numerals refer to like elements and wherein:

FIG. 1 illustrates an image display device system according to an embodiment of the present invention;

FIG. 2 is an internal block diagram of an image display device according to an embodiment of the present invention;

FIG. 3 is an internal block diagram of a controller in an image display device according to an embodiment of the present invention;

FIG. 4 illustrates an example of a 3D video signal format that may implement a 3D image;

FIG. 5 illustrates various scaling schemes of a 3D video signal;

FIG. 6 illustrates a perceived depth of a 3D image or a 3D object varies;

FIG. 7 shows how the perceived depth of an image or the like may be controlled;

FIGS. 8 and 9 illustrate an image display device and a remote control device according to an embodiment of the present invention;

FIG. 10 is a flow chart illustrating a method for operating an image display device according to an embodiment of the present invention;

FIGS. 11 to 13 illustrate a plurality of OSD objects displayed according to an embodiment of the present invention;

FIG. 14 is a flow chart illustrating a method for operating an image display device according to an example embodiment of the present invention;

FIG. 15 is a flow chart illustrating a method for operating an image display device according to an example embodiment of the present invention;

FIG. 16 is a flow chart illustrating a method for operating an image display device according to an example embodiment of the present invention; and

FIG. 17 illustrates two or more subtitle OSD objects displayed on an image display device according to an embodiment of the present invention.

### DETAILED DESCRIPTION

Embodiments of the present invention may provide an image display device and a method for operating the same, wherein various images such as user interface images or broadcast images may be displayed in multiple layers and a visual effect of each image may change according to a depth value of each layer.

Embodiments of the present invention may provide an image display device and a method for operating the same, wherein a user may arbitrarily control a perceived (or apparent) depth, a display position, and/or a display state of each image displayed in multiple layers or of objects that constitute the image.

Embodiments of the present invention may provide an image display device for displaying a plurality of OSD objects on a screen and a method for operating the same, wherein different perceived depths (or apparent depths) may be provided to the OSD objects to allow a user to conveniently receive various OSD objects.

Embodiments of the present invention may provide an image display device and a method for operating the same, wherein subtitles may be easily identified using differences between perceived depths (or apparent depths) of subtitle OSD objects that are OSD objects for displaying subtitles.

Embodiments of the present invention may provide an image display device and a method for operating the same that may provide a plurality of subtitles while allowing a user to freely control display states or display times of subtitles, a time interval between display of subtitles, and/or the like.

A method may be provided for operating an image display device capable of three-dimensionally displaying at least two OSD objects. The method may include displaying a first OSD object, and displaying a second OSD object having a different perceived depth from the first OSD object, wherein at least one of the first OSD object or the second OSD object includes multiple-view images and the perceived depth varies according to an interval between the multiple-view images. The method may also include receiving a user setting signal for at least one of the first OSD object and the second OSD object, and changing at least one of a perceived depth, a display position, and/or a display state of the first OSD object or the second OSD object according to the user setting signal.

An image display device may be provided that is capable of displaying at least two OSD objects. The image display device may include a controller for generating a first OSD object and generating a second OSD object having a different perceived depth from the first OSD object, wherein at least one of the first OSD object or the second OSD object includes multiple-view images and the perceived depth varies according to an interval between the multiple-view images. The image display device may also include a display unit for displaying the first OSD object and the second OSD object, and a user input unit for receiving a user setting signal for at least one of the first OSD object and the second OSD object. The controller may change at least one of a perceived depth, a display position, and/or a display state of the first OSD object or the second OSD object according to the user setting signal.

A method may be provided for operating an image display device capable of three-dimensionally displaying an object. The method may include reproducing a main image, generating a first subtitle OSD object for displaying a first subtitle of the main image, generating a second subtitle OSD object for displaying a second subtitle of the main image, and displaying the first subtitle OSD object and the second subtitle OSD object. The second subtitle OSD object may include multiple-view images and may have a different depth value from the first subtitle OSD object.

An image display device may be provided that is capable of three-dimensionally displaying an object. The image display device may include a controller for reproducing a main image, generating a first subtitle OSD object for displaying a first subtitle of the main image, and generating a second subtitle OSD object for displaying a second subtitle of the main image. The image display device may also include a display unit for displaying the first subtitle OSD object and the second subtitle OSD object. The second subtitle OSD object may include multiple-view images and may have a different depth value from the first subtitle OSD object.

A plurality of images or a plurality of objects displayed in multiple layers may be easily identified using perceived depths and visual effects that vary depending on the perceived depths. The user may freely set perceived depths of images displayed in multiple layers or perceived depths of objects that constitute the images.

According to an image display device and a method for operating the same, a plurality of subtitles of main images may be simultaneously or sequentially provide to the user. The user may select whether or not to display each of the plurality of subtitles and thus to receive a variety of information only when they desire to receive the information. When a plurality of subtitles are displayed for one or more main images, the user may easily identify each of the plurality of subtitles without confusion using 3D effects or the like.

The word “module” or “unit”, which may be added to the end of terms describing components, may be used merely for ease of explanation and may have no specific meaning or function with respect to the components. The words “module” and “unit” may also be used interchangeably.

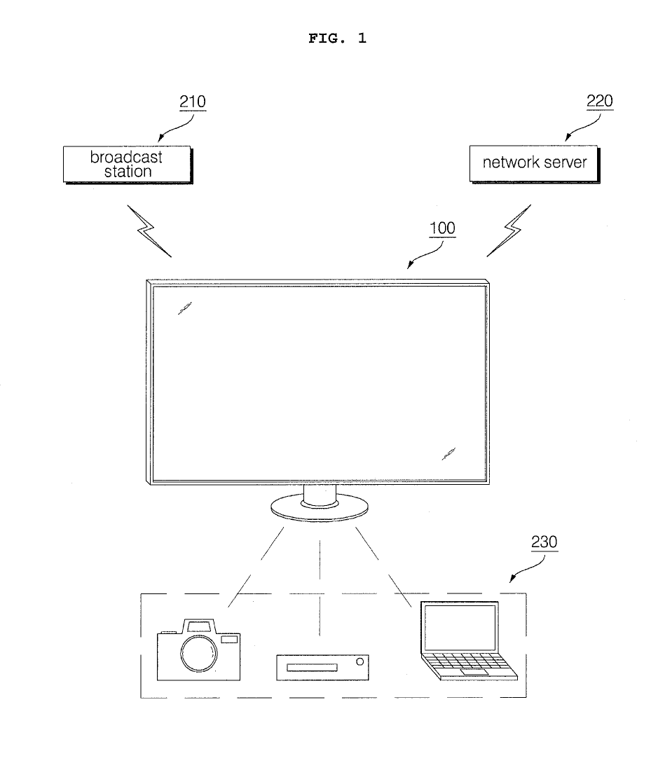

FIG. 1 illustrates an image display device system according to an embodiment of the present invention. Other embodiments and configurations are also within the scope of the present invention.

An image display device 100 may be associated with a broadcast station 210, a network server 220, and/or an external device 230.

The image display device 100 may receive a broadcast signal including a video signal transmitted by the broadcast station 210. The image display device 100 may process a video signal and an audio signal or a data signal included in the broadcast signal into a signal suitable for output by the image display device 100. The image display device 100 may output video or audio based on the processed video signal.

The image display device 100 may communicate with the network server 220. The network server 220 may be a device capable of transmitting and receiving signals to and from the image display device 100 through a network. For example, the network server 220 may be a mobile phone that can be coupled to the image display device 100 through a wired or wireless base station. The network server 220 may also be a device that may provide content to the image display device 100 over the Internet. A content provider may provide content to the image display device 100 using the network server 220.

The image display device 100 may communicate with the external device 230. The external device 230 may be a device that can directly transmit and receive signals to and from the image display device 100 either wirelessly or by wire. For example, the external device 230 may be a media storage device (or player) used by the user. That is, the external device 230 may be a camera, a DVD player, a Bluray player, a personal computer, and/or the like.

The broadcast station 210, the network server 220, and the external device 230 may transmit a signal including a video signal to the image display device 100. The image display device 100 may display an image based on the video signal included in the received signal. The image display device 100 may transmit signals, which have been transmitted from the broadcast station 210 and the network server 220 to the image display device 100, to the external device 230. The image display device 100 may also transmit signals, which have been transmitted from the external device 230 to the image display device 100, to the broadcast station 210 or to the network server 220. That is, the image display device 100 may not only directly play content included in signals transmitted from the network server 220 and the external device 230 but may also transmit the content to another device.

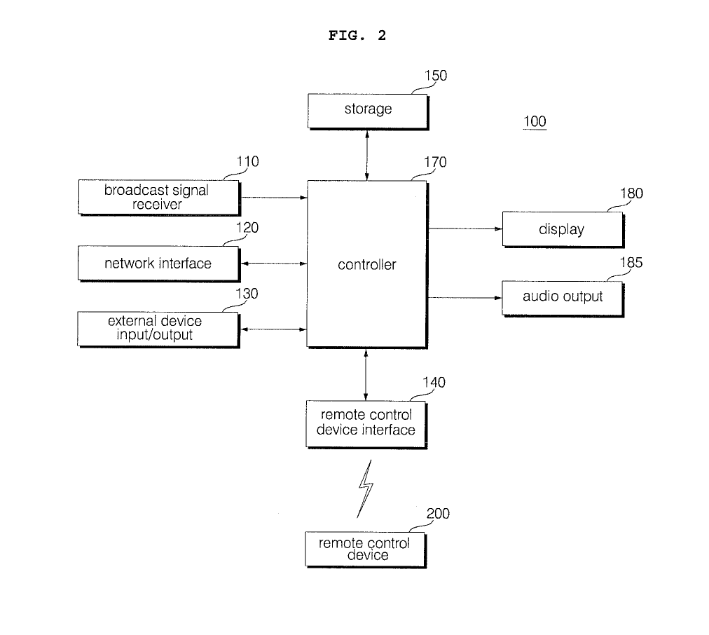

FIG. 2 is an internal block diagram of an image display device according to an embodiment of the present invention. Other embodiments and configurations are also within the scope of the present invention.

As shown in FIG. 2, the image display device 100 may include a broadcast signal receiver 110, a network interface 120, an external device input/output 130, a remote control device interface 140, a storage 150, a controller 170, a display 180, and an audio output 185.

The broadcast signal receiver 110 may receive Radio Frequency (RF) broadcast signals corresponding to all stored channels or a channel selected by the user from among RF broadcast signals received through an antenna from a broadcast station (denoted “210” in FIG. 1) and/or the like. The broadcast signal receiver 110 may convert the received RF broadcast signals into intermediate frequency signals or baseband video or audio signals and may then output the converted signals to the controller 170.

The broadcast signal receiver 110 may receive single-carrier RF broadcast signals according to an Advanced Television System Committee (ATSC) scheme or multi-carrier RF broadcast signals according to a Digital Video Broadcasting (DVB) scheme. The broadcast signal receiver 110 may sequentially select RF broadcast signals of all broadcast channels stored through a channel storage function from among received RF broadcast signals and may convert the selected RF broadcast signals into intermediate frequency signals or into baseband video or audio signals. A thumbnail list including a plurality of thumbnail images corresponding to the broadcast channels may then be displayed. Thus, the broadcast signal receiver 110 may sequentially/periodically receive RF broadcast signals of all selected or stored channels.

The network interface 120 may provide an interface for connection to a wired/wireless network including the Internet or to a network server (denoted “220” in FIG. 1) on the network.

The network interface 120 may include a wireless communication unit that allows the image display device 100 to be connected wirelessly to the Internet. A communication protocol such as wireless LAN (WLAN) (Wi-Fi), Wireless broadband (WiBro), World Interoperability for Microwave Access (WiMax), and/or High Speed Downlink Packet Access (HSDPA) may be used for wireless Internet access.

The network interface 120 may receive content or data provided by a content provider or a network operator through a network. That is, the network interface 120 may receive content such as a broadcast, game, or VOD and related information provided from the content provider through the network. The network interface 120 may also receive update information and update files of firmware provided by the network operator.

The network interface 120 may also be coupled to a communication network that enables video or audio communication. The communication network may indicate a network including a broadcast communication network, a public phone network, a mobile communication network, and/or the like connected through a LAN.

The external device input/output 130 may connect the image display device 100 and an external device (denoted “230” in FIG. 1). The external device input/output 130 may include an NV input/output unit and/or a wireless communication unit.

The external device input/output 130 may be connected wirelessly or by wire to an external device such as a Digital Versatile Disk (DVD) player, a Bluray player, a game console, a camera, a camcorder, and/or a (notebook) computer. The external device input/output 130 may transfer a video signal, an audio signal, and/or a data signal received from the connected external device to the controller 170 of the image display device 100. The external device input/output 130 may also output a video signal, an audio signal, and/or a data signal processed by the controller 170 to the connected external device.

An A/V input/output unit may be a module that allows a video signal and an audio signal from an external device to be input to the image display device 100. The A/V input/output unit may be one or more of an Ethernet terminal, a USB terminal, a Composite Video Banking Sync (CVBS) terminal, a component terminal, an (analog) S-video terminal, a Digital Visual Interface (DVI) terminal, a High Definition Multimedia Interface (HDMI) terminal, an RGB terminal, and/or a D-SUB terminal.

The wireless communication unit may perform wireless communication with another external device. The image display device 100 may be connected to another external device through a network according to a communication protocol such as Bluetooth, Radio Frequency Identification (RFID), infrared Data Association (IrDA), Ultra Wideband (UWB), and/or Zig Bee.

The external device input/output 130 may also be connected to one of a variety of set-top boxes through at least one of the various terminals described above to perform input/output operations with the connected sep-top box.

For example, when the set-top box is an Internet Protocol (IP) TV set-top box, the external device input/output 130 may transfer a video, audio, and/or data signal processed by the IP TV set-top box to the controller 170 to allow bidirectional communication. Signals processed by the controller 170 may be transferred to the IP TV set-top box.

The IP TV may include an ADSL TV, a VDSL TV, an FTTH TV, and/or the like according to a type of the transmission network and may also include a TV over DSL, a video over DSL, a TV over IP (TVIP), a Broadband TV (BTV), and/or the like. The IP TV may also include an Internet TV, a full browsing TV, and/or the like that can connect to the Internet.

The remote control device interface 140 may include a wireless communication unit that can transmit and receive signals wirelessly to and from the remote control device 200 and a coordinate calculation unit that can calculate coordinates of a pointer corresponding to movement of the remote control device 200. The remote control device interface unit 140 may transmit and receive signals wirelessly to and from the remote control device 200 through an RF module. The remote control device interface 140 may receive signals that the remote control device 200 has transmitted according to an IR communication protocol through the RF module.

The coordinate calculation unit of the remote control device interface 140 may perform hand trembling or error correction from a signal corresponding to movement of the remote control device 200 that has been received through the wireless communication unit of the remote control device interface 140. The coordinate calculation unit may calculate coordinates of a pointer to be displayed on the display of the image display device 100 after hand trembling or error correction.

A signal transmitted by the remote control device 200, which has been input to the image display device 100 through the remote control device interface 140, may be output to the controller 170 of the image display device 100. The controller 170 may determine information regarding key control or movement of the remote control device 200 from the signal transmitted by the remote control device 200 and may generate and output various control signals for controlling an operation of the image display device 100 according to the determined information.

The remote control device 200 may calculate pointer coordinates corresponding to movement of the remote control device 200 and may output the calculated pointer coordinates to the remote control device interface 140. The remote control device interface 140 may transmit information regarding pointer coordinates received from the remote control device 200 to the controller 170 without an additional procedure such as hand trembling or error correction.

The storage 150 may store a video signal and audio and data signals associated with the video signal that are input to the image display device 100. For example, a moving image storage command may be input to the image display device 100 that is reproducing a moving image based on a broadcast signal. The image display device 100 may store at least part of the moving image that is being reproduced in the storage 150 in response to the moving image storage command input to the image display device 100. When a command to reproduce a stored moving image is input to the image display device 100, the image display device 100 may read a video signal and audio and data signals associated with the video signal. The image display device 100 may reproduce a moving image based on the read signal.

The controller 170 may control overall operation of the image display device 100. The controller 170 may receive a signal transmitted by the remote control device 200 or a different type of control command input unit. The image display device 100 may also receive a command through a local key provided on the image display device 100. The controller 170 may determine a command included in the received signal or a command corresponding to the local key and control the image display device 100 according to the command.

For example, when the user inputs a command to select a channel, the controller 170 may control the broadcast signal receiver 110 to allow a broadcast signal provided in the selected channel to be input through the broadcast signal receiver 110. The controller 170 may also process and output a video signal and an audio signal of the selected channel to the display 180 or the audio output 185. The controller 170 may also allow information of the channel selected by the user or the like to be output, together with the video signal and the audio signal, through the display 180 or the audio output 185.

The controller 170 may process a video signal or an audio signal based on information included in a data signal that is received together with the video signal or audio signal. For example, the controller 170 may determine a format of a video signal input to the image display device 100 using a data signal associated with the video signal and may process the video signal input to the image display device 100 according to the determined format.

The controller 170 may generate, from a data signal associated with a video signal, an On Screen Display (OSD) signal that can display an OSD associated with an image generated based on the video signal. The controller 170 may also generate a graphical user interface to allow the user to check related information on the image display device 100 or to input an image display device control command to the image display device 100.

The user may also input a different type of video or audio output command through the remote control device 200 or a different type of control command input unit. For example, the user may desire to view a camera or camcorder video signal input through the external device input/output 130 rather than to view a broadcast signal. In this case, the controller 170 may process a video signal or an audio signal input to the image display device 100 through a USB input unit or the like of the external device input/output 130 so that the video signal or audio signal input to the image display device 100 is output through the display 180 or the audio output 185.

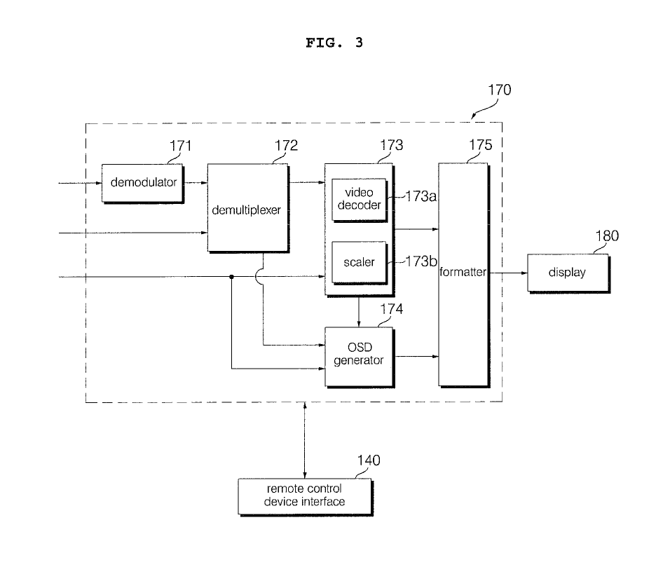

The controller 170 may process a 2D or 3D video signal input from the outside so that the video signal can be displayed on the display 180. The controller 170 may process the video signal so that the generated graphical user interface may be three-dimensionally displayed on the display 180. The controller 170 may be described below with reference to FIG. 3.

The display 180 may convert a video signal, a data signal, and an OSD signal processed by the controller 170 or a video signal, a data signal, etc., received through the external device input/output 130 into respective RGB signals to generate drive signals. The display 180 may display a screen according to the generated drive signals. The display 180 may be a PDP, an LCD, an OLED, a flexible display, and/or the like. The image display device 100 and the display 180 may perform a 3D display.

3D display schemes may be classified into an assisted display scheme and a standalone display scheme according to how a user perceives a 3D image.

The standalone display scheme may be a method in which a 3D image may be implemented on a display without a separate subsidiary device. The user may view a 3D image on a display using the standalone display scheme without an additional device (for example., polarized glasses). Examples of the standalone display scheme may include a lenticular scheme, a parallax barrier, and/or the like.

The assisted display scheme may implement a 3D image using a subsidiary device. Examples of the assisted display scheme may include a head-mount display (HMD), a glass-based scheme, and/or the like. Glasses used in the glass-based scheme may include polarized glasses, shutter glasses, spectrum filters, and/or the like.

The display 180 may be constructed as a touch screen to function not only as an output device but also as an input device.

The audio output 185 may receive audio signals (for example, stereo signals, 3.1 channel signals, and/or 5.1 channel signals) processed by the controller 170 and output audio according to the audio signal. The audio output 185 may be implemented as various types of speakers.

FIG. 3 is an internal block diagram of the controller 170 in the image display device according to an embodiment of the present invention. Other embodiments and configurations are also within the scope of the present invention.

The controller 170 may include a demodulator 171, a demultiplexer 172, a decoder 173, an OSD generator 174, and a formatter 175. The demodulator 171 may perform an operation for demodulating a broadcast signal received by the broadcast signal receiver 110.

For example, the demodulator 171 may receive a digital intermediate frequency (DIF) signal converted by the broadcast signal receiver 110 and may perform a demodulation operation for the same. The demodulator 171 may perform channel decoding. The demodulator 171 may include a convolution decoder, a de-interleaver, a Reed-Solomon decoder, and/or the like to perform convolution decoding, de-interleaving, Reed-Solomon decoding, and/or the like.

The demodulator 171 may output a stream signal (TS) after performing demodulation and channel decoding. The stream signal may be a multiplexed signal containing a video signal, an audio signal, and/or a data signal. For example, the stream signal may be an MPEG-2 Transport Stream (TS) in which an MPEG-2 video signal, a Dolby AC-3 audio signal, and/or the like are multiplexed. More specifically, the MPEG-2 TS may include a 4-byte header and a 184-byte payload.

The demodulator 171 may include individual units corresponding respectively to an ATSC scheme and a DVB scheme. The stream signal output by the demodulator 171 may be input to the demultiplexer 172.

The demultiplexer 172 may demultiplex the received stream signal (for example, the MPEG-2 TS) into a video signal, an audio signal, and a data signal. The stream signal input to the demultiplexer 172 may be a stream signal output from the demodulator 171, the network interface 120, and/or the external device input/output 130.

The demultiplexed data signal may be an encoded data signal. The encoded data signal may include Electronic Program Guide (EPG) information including broadcast information such as a title, a start time, and an end time of a broadcast program that is broadcast on each channel. For example, the EPG information may include ATSC-Program and System Information Protocol (ATSC-PSIP) information in the case of the ATSC scheme and may include DVB-Service Information (DVB-SI) in the case of the DVB scheme.

The decoder 173 may decode the demultiplexed signals. The decoder 173 may include a video decoder 173a that decodes the demultiplexed video signal and a scaler 173b that adjusts a resolution of the decoded video signal so that the signal can be output through the image display device 100.

The OSD generator 174 may generate an OSD signal so that an object is displayed as an OSD on the display 180. The OSD may indicate information associated with an image displayed on the display 180. The OSD may include a user interface for receiving a control signal, a user command, and/or the like that can control an operation of the image display device 100.

The OSD generator 174 may extract a thumbnail image corresponding to a time of reproduction of content that is being reproduced or that may be reproduced on the image display device 100. The OSD generator 174 may generate an OSD signal to allow the user to perceive or view a 3D object including the extracted thumbnail image and may then output the generated OSD signal to the formatter 175.

The formatter 175 may determine a format of an input video signal with reference to a data signal associated with the video signal. The formatter 175 may convert an input video signal into a format suitable for the display 180 and may then output the converted video signal to the display 180.

The image display device 100 may display a 3D image on the display 180. The formatter 175 may convert the input video signal to generate a 3D video signal according to a specific format suitable for display on the display 180. The 3D video signal may include a left-eye video signal and/or a right-eye video signal. A left-eye image and a right-eye image may be used to implement a 3D image. The left-eye video signal may be a video signal for displaying a left-eye image and the right-eye video signal may be a video signal for displaying a right-eye image. The formatter 175 may output the generated 3D video signal to the display 180. The display 180 may display a 3D image based on the generated 3D video signal.

The image display device 100 may display an OSD as a 3D object according to an OSD signal generated by the OSD generator 174. The OSD formatter 175 may convert the OSD signal generated by the decoder 173 into a 3D video signal in a format that can be displayed on the display 180 so that multiple-view images (for example, a left-eye image and a right-eye image) that constitute the 3D object are displayed on the display 180 and may then output the 3D video signal to the display 180.

The image display device 100, which may separately include a user interface generation unit, may further include a mixer that can mix video signals output by the decoder 173 and the OSD generator 174 with a user interface video signal output by the user interface generation unit. The mixer may be included in the formatter 175 in order to mix video signals output by the decoder 173 and the OSD generator 174.

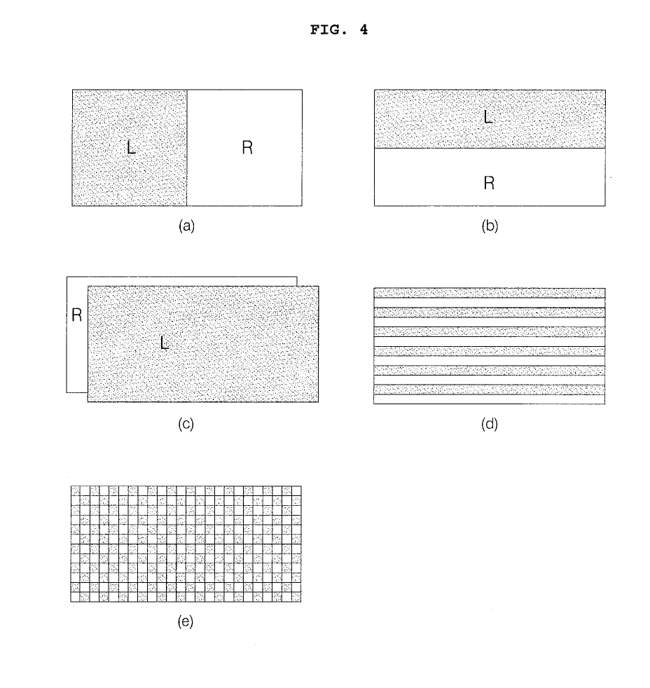

FIG. 4 illustrates an example of a 3D video signal format that may implement a 3D image. The 3D video signal format may be determined according to a method of arranging a left-eye image and a right-eye image generated to implement a 3D image.

A 3D image may include multiple-view images. The user may view the multiple-view images through left and right eyes. The user may experience a stereoscopic effect of the 3D image through a difference between images perceived by the left and right eyes. The multiple-view images for implementing a 3D image may include a left-eye image that the user may be perceived by the left eye and a right-eye image that the user may be perceived by the right eye.

A scheme in which the left-eye image and the right-eye image are arranged left and right as shown in FIG. 4(a) may be referred to as a “side by side format”. A scheme in which the left-eye image and the right-eye image are arranged up and down as shown in FIG. 4(b) may be referred to as a “top/down format”. A scheme in which the left-eye image and the right-eye image are arranged at different times through time division as shown in FIG. 4(c) may be referred to as a “frame sequential format”. A scheme in which the left-eye image and the right-eye image are mixed in lines as shown in FIG. 4(d) may be referred to as an “interlaced format”. A scheme in which the left-eye image and the right-eye image are mixed in boxes as shown in FIG. 4(e) may be referred to as a “checker box format”.

A video signal included in a signal input to the image display device 100 from the outside may be a 3D video signal that may implement a 3D image. A graphical user interface video signal representing information regarding the image display device 100 or a graphical user interface video signal generated to allow input of a command regarding the image display device 100 may be a 3D video signal. The formatter 175 may mix the 3D video signal included in the signal input to the image display device 100 from the outside and the graphical user interface 3D video signal and may then output the mixed video signal to the display 180.

The formatter 175 may determine a format of the mixed 3D video signal with reference to an associated data signal. The formatter 175 may process a 3D video signal so as to be suitable for the determined format and may output the processed 3D video signal to the display 180. When a received 3D video signal has a format that can not be output through the display 180 is limited, the formatter 175 may convert the received 3D video signal to be suitable for the 3D video signal format that can be output through the display 180 and may then output the converted video signal to the display 180.

The OSD generator 174 may generate an On Screen Display (OSD) signal. More specifically, the OSD generator 174 may generate a signal for displaying various information as graphics or text on the screen of the display 180 based on at least one of a video signal and an audio signal or a user input signal input through a different type of control command input unit. The OSD generator 174 may also generate a signal for displaying a graphic or text that allows input of a control command to the image display device 100. The generated OSD signal may be output, together with a video signal that has been subjected to image processing and a data signal that has been subjected to data processing, to the display 180.

As a signal generated for graphic or text display, the OSD signal may include information regarding a user interface screen, various menu screens, widgets, and/or icons that may be displayed on the display 180. The OSD generator 174 may generate the OSD signal as a 2D video signal or a 3D video signal. The OSD signal generated by the OSD generator 174 may include a graphical user interface 3D video signal that is mixed with another video signal.

The display 180 may display an object according to the OSD signal generated by the OSD generator 174. The object may be one of a volume control button, a channel control button, an image display device control menu, an icon, a navigation tab, a scroll bar, a progress bar, a text bar, and/or a window.

Through the object displayed on the display 180, the user may view or read information regarding the image display device 100 or information regarding an image that is being displayed on the image display device 100. Additionally, the user may input a command to the image display device 100 through the object displayed on the display 180. The term “3D object” may refer to an object to which stereoscopic effects have been applied to provide a 3D sensation. The 3D object may be a PIP image, an EPG representing broadcast program information, various image display device menus, widgets, icons, and/or the like.

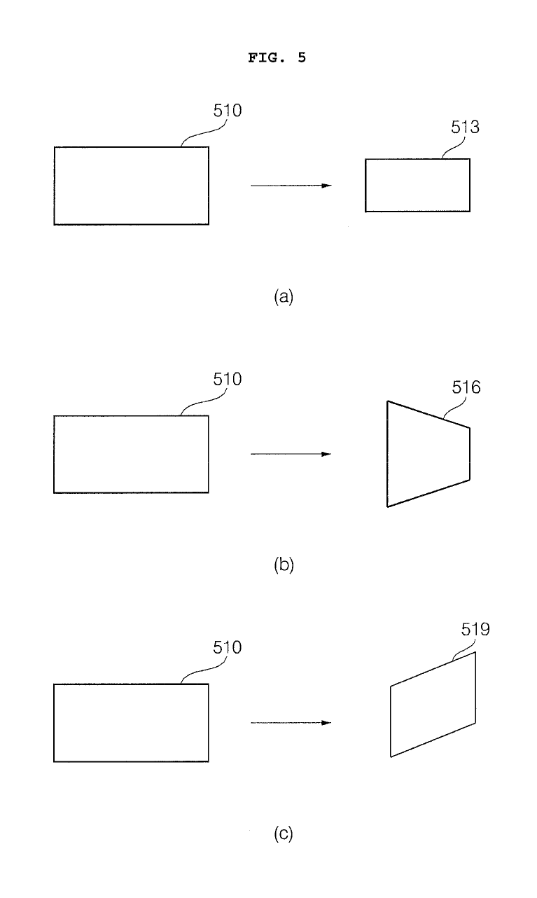

FIG. 5 illustrates various scaling schemes of a 3D video signal or various possible forms of an image. Size control or slope control of a 3D object may be described below with reference to FIG. 5.

The controller 170 or a module for image processing such as a scaler included in the controller 170 may enlarge or reduce an entirety of a 3D video signal or a 3D object 510 in a 3D video signal at a specific ratio as shown in FIG. 5(a), where the reduced 3D object may be denoted “513”. This may be a general image processing function of the scaler or controller.

The controller 170 may modify a screen into a form of a polygon such as a trapezoid or a parallelogram or may generate a screen in a form of a polygon such as a trapezoid or parallelogram to represent an image rotated by a specific angle or inclined in a specific direction. A video signal processed into the form of a trapezoid or a parallelogram for displaying an inclined or rotated screen may be received. In an example where the controller 170 generates and outputs a 3D object corresponding to an OSD, a 3D video signal, and/or the like to the display 180, the controller 170 may generate the 3D object as an image having a trapezoidal form 516 as shown in FIG. 5(b) or an image having a parallelogram form 519 as shown in FIG. 5(c).

Not only when an image received from a broadcast station (denoted “210” in FIG. 1), a network server (denoted “230” in FIG. 1), or an external input device (denoted “230” in FIG. 1) or a 3D image or a 3D object such as an OSD generated by the controller 170 may be enlarged or reduced as shown in FIG. 5(a), but also when a 3D video signal or the like is generated or processed into a trapezoidal form 516 or a parallelogram form 519 as shown in FIG. 5(b) or FIG. 5(c), the stereoscopic effect (i.e., a 3D effect) of the 3D video signal or the 3D object in the 3D video signal may be more emphasized. This may also serve to diversify and maximize the stereoscopic sensation of the image perceived by the user.

The slope or rotation effect that is provided to the image according to the shape of the image may be controlled by increasing or reducing a difference between the two parallel sides of the trapezoidal form 516 illustrated in FIG. 5(b) or the difference between the two diagonal dimensions of the parallelogram form 519 illustrated in FIG. 5(c).

Different time intervals may be applied to parts of one 3D image or one 3D object to generate a tilting effect. That is, one 3D image or one 3D object may have both parts with large perceived depths (or depth effects) and parts with small perceived depths so that the image is viewed as inclined or rotated. This may indicate that different time intervals may be applied to parts of a pair of left-eye and right-eye images.

When one of a left-eye image and a right-eye image for displaying a 3D image or a 3D object is generated as an image having a form shown in FIG. 5 by the OSD generator 174 or the scaler 173b in the controller 170, the generated left-eye or right-eye image may be copied to generate the other right-eye or left-eye image, thereby generating a pair of left-eye and right-eye images.

On the other hand, scaling of the 3D video signal or the 3D object may also be performed by the formatter 175 of the controller 170. Each 3D video signal shown in FIG. 5 may be a left-eye video signal, a right-eye video signal, and/or a combination of left-eye and right-eye video signals.

The formatter 175 may receive a decoded video signal and separate a 2D video signal or a 3D video signal from the received video signal and may again separate the 3D video signal into a left-eye video signal and a right-eye video signal. The left-eye video signal and the right-eye video signal may be scaled into at least one of the various exemplary forms illustrated in FIG. 5 and the scaled video signal may then be output in a specific format shown in FIG. 4. Scaling may be performed before or after the output format is created.

The formatter 175 may receive an OSD signal of the OSD generator 174 or an OSD signal mixed with a decoded video signal and separate a 3D video signal from the received OSD signal and may then separate the 3D video signal into multiple-view video signals. For example, the 3D video signal may be separated into a left-eye video signal and a right-eye video signal, the separated left-eye and right-eye video signals may be scaled as shown in FIG. 5, and the scaled video signals may then be output in a specific format as shown in FIG. 4.

The OSD generator 174 may directly perform the video signal generation procedure or scaling procedure described above on an OSD output. When the OSD generator 174 directly performs scaling on an OSD, the formatter 175 may not need to perform scaling on the OSD. The OSD generator 174 may not only generate the OSD signal but may also scale the OSD signal according to depth or slope of the OSD and then output the OSD signal in a suitable format. The format of the OSD signal output by the OSD generator 174 may be one of the formats of a left-eye video signal and a right-eye video signal or various combined formats of left and right images as shown in FIG. 4. The output format may be the same as the output format of the formatter 175.

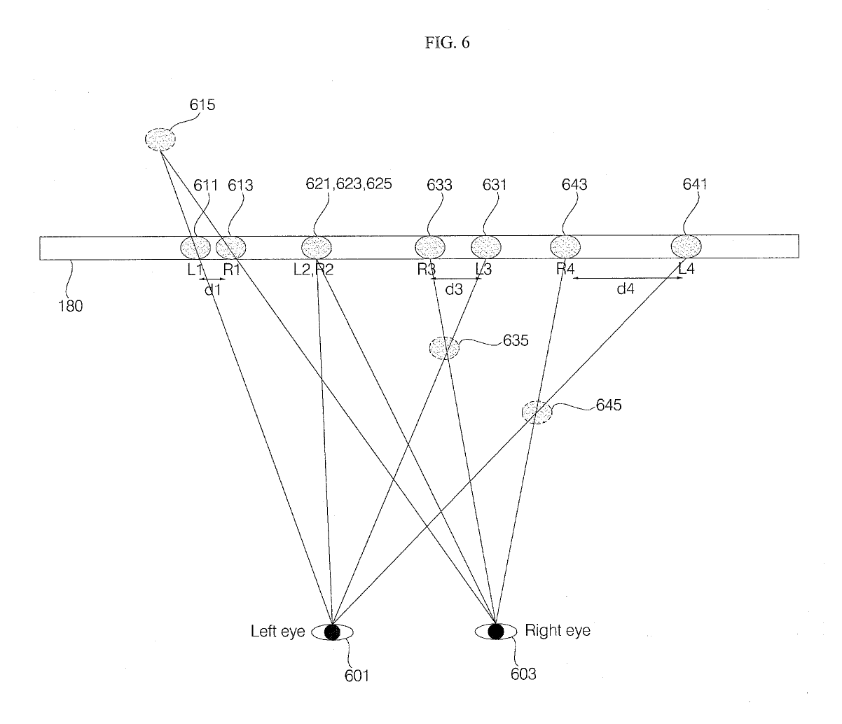

FIG. 6 illustrates how a perceived depth of a 3D image or a 3D object varies.

A 3D image may include multiple-view images that may be exemplified by a left-eye image and a right-eye image. How a position at which an image is formed as perceived by the user may change depending on an interval between the left-eye image and the right-eye image is shown in FIG. 6. The stereoscopic effect or perspective effect of an image perceived by the user according to the distance or time difference between left-eye and right-eye images may be described below with reference to FIG. 6.

FIG. 6 shows a plurality of images or a plurality of objects having different perceived depths (or apparent depths). The shown objects may be referred to as a first object 615, a second object 625, a third object 635, and a fourth object 645.

The first object 615 may include a first left-eye image based on a first left-eye video signal and a first right-eye image based on a first right-eye video signal. That is, a video signal for displaying the first object may include the first left-eye video signal and the first right-eye video signal. FIG. 6 shows positions at which the first left-eye image based on the first left-eye video signal and the first right-eye image based on the first right-eye video signal are displayed on the display 180. FIG. 6 also shows an interval between the first left-eye image and the first right-eye image displayed on the display 180. The above description of the first object may be applied to the second to fourth objects. A left-eye image and a right-eye image displayed on the display 180 for each object, the interval between the two images, and the object may be described with like reference numerals for ease of explanation.

The first object 615 may include a first right-eye image 613 (shown as “R1” in FIG. 6) and a first left-eye image 611 (shown as “L1” in FIG. 6). The interval between the first right-eye image 613 and the first left-eye image 611 may be set to dl. The user may perceive that an image is formed at an intersection between a line connecting a left eye 601 and the first left-eye image 611 and a line connecting a right eye 603 and the first right-eye image 613. Thus, the user may perceive that the first object 615 is located behind the display 180. The distance between the display 180 and the first object 615 as perceived by the user may be expressed as a depth. The depth of the 3D object that the user perceives to be located behind the display 180 may have a negative value (−). Thus, the depth of the first object 615 may have a negative value.

The second object 625 may include a second right-eye image 623 (shown as “R2” in FIG. 6) and a second left-eye image 621 (shown as “L2” in FIG. 6). According to this embodiment, the second right-eye image 623 and the second left-eye image 621 may be displayed at a same position on the display 180. That is, the interval between the second right-eye image 623 and the second left-eye image 621 may be 0. The user may perceive that an image is formed at an intersection between a line connecting the left eye 601 and the second left-eye image 621 and a line connecting the right eye 603 and the second right-eye image 623. Thus, the user may perceive that the second object 625 is displayed on the display 180. The second object 625 may be referred to as a “2D object”. The second object 625 may have a depth of zero that is the same as the depth of the display 180.

3D objects that are perceived to be located at a position protruding from the display 180 toward the user may be described below using the third object 635 and the fourth object 645 as examples. How the degree of the perspective or stereoscopic effect perceived by the user may change as an interval between the left-eye image and the right-eye image changes may also be described below with reference to the third object 635 and the fourth object 645 as examples.

The third object 635 may include a third right-eye image 633 (shown as “R3” in FIG. 6) and a third left-eye image 631 (shown as “L3” in FIG. 6). The interval between the third right-eye image 633 and the third left-eye image 631 may be set to d3. The user may perceive that an image is formed at an intersection between a line connecting the left eye 601 and the third left-eye image 631 and a line connecting the right eye 603 and the third right-eye image 633. Thus, the user may perceive that the third object 635 is located in front of the display 180 (i.e., located at a position nearer to the user than the display 180). That is, the third object 635 may be perceived by the user to be located at a position protruding from the display 180 toward the user. The depth of the 3D object that the user perceives to be located in front of the display 180 may have a positive value (+). Thus, the depth of the third object 635 may have a positive value.

The fourth object 645 may include a fourth right-eye image 643 (shown as “R4” in FIG. 6) and a fourth left-eye image 641 (shown as “L4” in FIG. 6). The interval between the fourth right-eye image 643 and the fourth left-eye image 641 may be set to d4. The intervals d3 and d4 satisfy an inequality of d3<d4. The user may perceive that an image is formed at an intersection between a line connecting the left eye 601 and the fourth left-eye image 641 and a line connecting the right eye 603 and the fourth right-eye image 643. Thus, the user may perceive that the fourth object 645 is located in front of the display 180 (i.e., located at a position nearer to the user than the display 180), and that the fourth object 645 is also located nearer to the user than the third object 635. That is, the fourth object 645 may be perceived by the user to be located at a position protruding from both the display 180 and the third object 635 toward the user. The depth of the fourth object 645 may have a positive value.

The image display device 100 may adjust the positions of a left-eye image and a right-eye image displayed on the display 180 so that the user perceives that an object including the left-eye and right-eye images is located behind or in front of the display 180. The image display device 100 may also adjust the interval between a left-eye image and a right-eye image displayed on the display 180, thereby adjusting the perceived depth of an object including the left-eye and right-eye images.

From the above description with reference to FIG. 6, it may be seen that whether the depth of an object including a left-eye image and a right-eye image has a positive value or a negative value is determined according to the left and right display positions of the left-eye and right-eye images. As described above, an object having a positive depth may be perceived by the user to be located protruding from the display 180. On the other hand, an object having a negative depth may be perceived by the user to be located behind the display 180.

It can also be understood from FIG. 6 that the perceived depth of the object (i.e., the distance between the display 180 and the position at which the 3D image is located as perceived by the user) may vary depending on an absolute value of the interval between the left-eye and right-eye images.

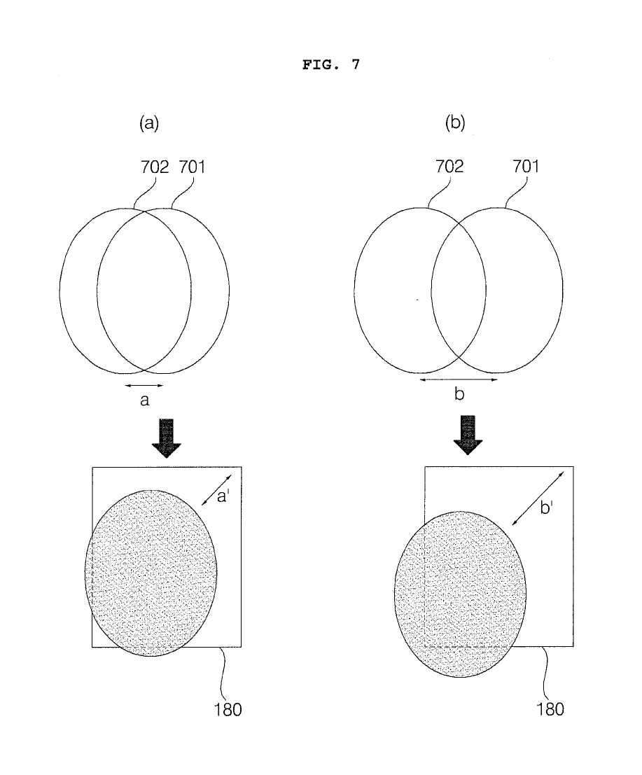

FIG. 7 shows how the perceived depth of an image may be controlled. It can be seen from FIG. 7 that the perceived depth of the same image or the same 3D object may vary according to the interval between a left-eye image 701 and a right-eye image 702 displayed on the display 180. The depth of the display 180 may be set to zero. The depth of an image that is perceived to be located protruding from the display 180 may be set to a positive value.

The interval between a left-eye image 701 and a right-eye image 702 shown in FIG. 7(a) is “a”. The interval between a left-eye image 701 and a right-eye image 702 shown in FIG. 7(b) is “b”. That is, the interval between the left-eye image 701 and the right-eye image 702 shown in FIG. 7(a) may be greater than that of FIG. 7(b).

The perceived depth of the 3D image or the 3D object shown in FIG. 7(a) may be greater than the perceived depth of the 3D image or the 3D object shown in FIG. 7(b) as described above with reference to FIG. 6. When the perceived depths of the 3D images or the 3D objects shown in FIGS. 7(a) and 7(b) are numerically represented by a′ and b′, respectively, it can be seen from the relation of a<b described above that the perceived depths a′ and b′ may also satisfy a relation of a′<b′. That is, when a 3D image viewed as protruding from the screen is implemented, the expressed perceived depth may be increased or decreased by increasing or decreasing the interval between the left-eye image 701 and the right-eye image 702.

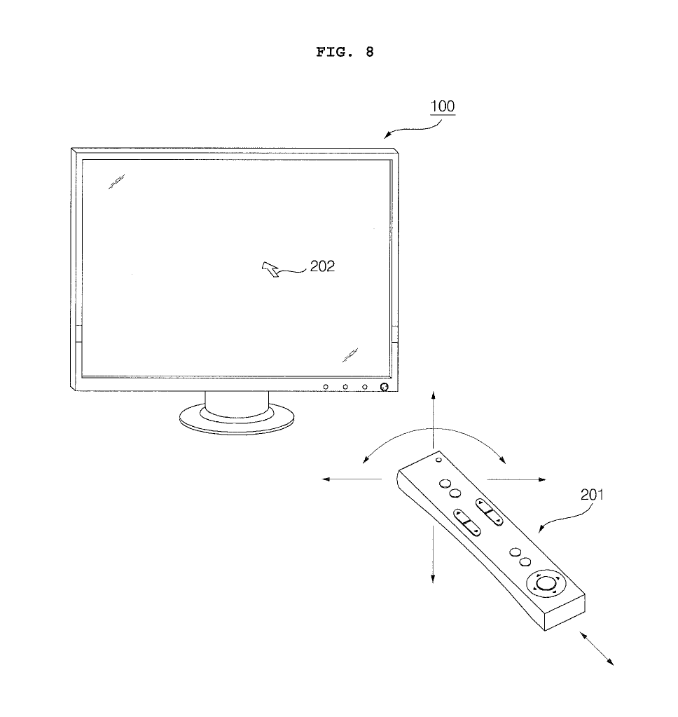

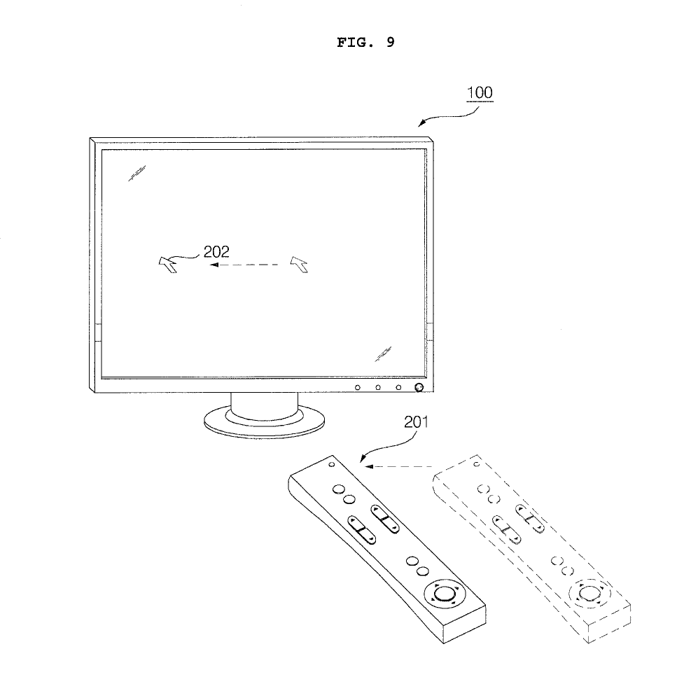

FIGS. 8 and 9 illustrate an image display device and a remote control device according to an embodiment of the present invention. Other embodiments and configurations are also within the scope of the present invention.

The image display device 100 may be controlled by a signal transmitted by the remote control device 200. The user may input a command such as power on/off, channel up/down, and volume up/down to the image display device 100 using the remote control device 200. The remote control device 200 may transmit a signal including a command corresponding to control by the user to the image display device 100. The image display device 100 may identify the signal received from the remote control device 200 and may generate a corresponding control signal or may perform an operation corresponding to the command included in the signal.

The remote control device 200 may transmit a signal to the image display device 100 according to an IR communication protocol. The remote control device 200 may transmit a signal to the image display device 100 or may receive a signal transmitted by the image display device 100 according to a different type of wireless communication protocol. The remote control device 200 may detect movement of the user and transmit a signal including a command corresponding to the detected movement to the image display device 100. In the following description, such a remote control device 200 may be exemplified by a pointing device. According to various embodiments, not only the pointing device but also a general wireless/wired mouse, an air mouse, and/or various other pointing devices, remote controllers in various shapes such as rings, bracelets, and/or thimbles may each be used as the remote control device 200.

In the embodiment described with reference to FIGS. 8 and 9, a pointing device 201, the perspective views of which are shown in FIGS. 8 and 9, may be employed as an example of the remote control device 200 that may input a command to the image display device 100 in order to remotely control the image display device 100.

The pointing device 201 may transmit and receive signals to and from the image display device 100 according to an RF communication protocol. As shown in FIG. 8, a pointer 202 corresponding to the pointing device 201 may be displayed on the image display device 100.

The user may rotate or move the pointing device 201 up, down, left, right, forward, and/or backward, for example. The pointer 202 displayed on the image display device 100 may move in response to movement of the pointing device 201. FIG. 9 illustrates an example where the pointer 202 displayed on the image display device 100 may move in response to movement of the pointing device 201.

In the example shown in FIG. 9, when the user moves the pointing device 201 left, the pointer 202 displayed on the image display device 100 may also move left in response to movement of the pointing device 201. To accomplish this, the pointing device 201 may include a sensor capable of detecting movement. Information regarding movement of the pointing device 201 detected through the sensor of the pointing device 201 may be transmitted to the image display device 100. The image display device 100 may calculate coordinates of the pointer 202 from information regarding movement of the pointing device 201. The image display device 100 may display the pointer 202 according to the calculated coordinates.

As shown in FIGS. 8 and 9, the pointer 202 displayed on the image display device 100 may move in response to vertical or horizontal movement or rotation of the pointing device 201. The movement speed or direction of the pointer 202 may correspond to the movement speed or direction of the pointing device 201.

To accomplish operations or functions of the pointing device 201 described above, the pointing device 201 may include lower modules such as a wireless communication unit, a user input unit, a sensing unit, a remote control signal output unit, a power supply unit, a remote control information storage unit, and/or a remote controller. That is, the remote controller of the pointing device 201 may process information or a signal detected through the user input unit and/or the sensing unit to generate a remote control signal. The remote control signal may be generated, for example, based on information obtained from the user input unit such as information indicating a touched or pressed position of a keypad or button of the user input unit or information indicating a time during which the keypad or button is kept pressed and information obtained from the sensing unit such as information indicating coordinates of a position to which the pointing device has been moved or indicating an angle to which the pointing device has been rotated.

The remote control signal generated through the above procedure may be transmitted to the image display device through a remote control wireless communication unit. More specifically, a remote control signal output through the remote control wireless communication unit may be input to the remote control device interface 140 of the image display device 100. The remote control wireless communication unit may receive a wired/wireless signal transmitted by the image display device.

The remote control information storage unit may store various types of programs and application data required for control or operation of the image display device or the pointing device. For example, the remote control information storage unit may store a frequency band used when wireless communication is performed between the image display device and the pointing device so that the stored remote control information regarding the frequency band may be used for a next communication.

The power supply unit may be a module for providing power or the like required to drive the pointing device. For example, when the remote controller outputs a signal issuing an instruction to temporarily stop or resume power supply according to movement of the pointing device detected by the sensing unit, the power supply unit may determine whether or not to supply power according to the control signal, thereby saving power during times when the pointing device is not used or is not in operation.

In another example, a specific command may be set to be input to the image display device 100 in response to movement of the pointing device 201. That is, a specific command may be input or generated only through movement of the pointing device 201 even when it is not detected that a specific pressure, touching, and/or the like have been applied to the user input unit. For example, a size of an image displayed on the image display device 100 may be increased or decreased by moving the pointing device 201 forward or backward. The examples of the pointing device may not limit the scope of the present invention.

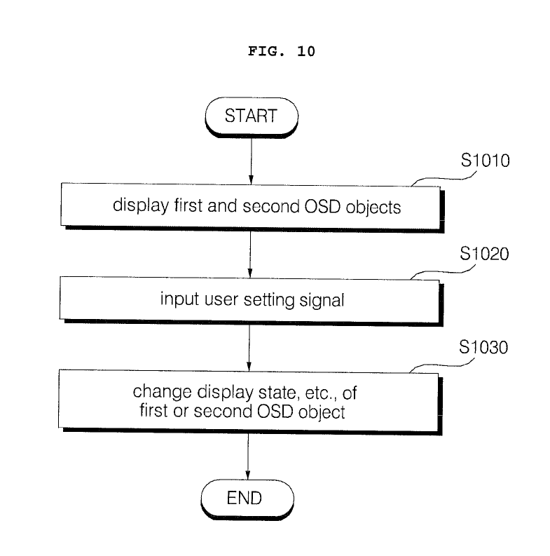

FIG. 10 is a flow chart illustrating a method for operating an image display device according to an embodiment of the present invention.

The image display device may be capable of three-dimensionally displaying an image. In one exemplary method for three-dimensionally displaying an image, multiple-view images may be displayed at specific time intervals to display a 3D image or a 3D object.

The controller 170 may generate a first OSD object and a second OSD object. Depth values of the first OSD object and the second OSD object may be set to be different. Thus, the first OSD object and the second OSD object may have different depth values. When the depth value of a same plane as the display 180 is defined to be zero, it is assumed that an object viewed to be located behind the display 180 has a negative (−) depth value and an object viewed to be located in front of the display 180 has a positive (+) depth value.

Although the depth values of the first and second OSD objects are not limited, it is assumed in the embodiment described with reference to FIG. 10 that the first and second OSD objects are displayed in multiple layers. In another embodiment, the first and second OSD objects may be displayed with initial depth values of the first and second OSD objects set to be equal and then the depth values of the first and second OSD objects may change to be different according to a command input by the user.

Both the example where the initial depth values of the first and second OSD objects are set to be different and the example where the depth values of the first and second OSD objects are changed to be different according to a user setting signal after depth values of the first and second OSD objects are set to be equal may be considered to belong to the example where the first and second OSD objects are displayed in multiple layers as described below. That is, a plurality of OSD objects may be displayed in multiple layers on the display 180 with the first and second OSD objects located in different layers. Additionally, although the first and second OSD objects may be initially included in one layer, depth values of the first and second OSD objects may then change so that the first and second OSD objects have different at specific time intervals depths and the first and second OSD objects are displayed as components of different layers.

At least one of the first or second OSD objects may include multiple-view images. That is, each of the first and second OSD objects may include multiple-view images or only one of the first and second OSD objects may also include multiple-view images. The depth value of each OSD object may be adjusted (i.e., increased or decreased) using the interval between the multiple-view images (i.e., left-eye and right-eye images) of the OSD object.

The display 180 may display the first OSD object and the second OSD object (S1010). The user input unit may receive a user setting signal, which is input by the user, and may transfer the user setting signal to the controller 170 (S1020). The user may input the user setting signal for one or more OSD objects. The user may select or activate one or more OSD objects when they input a user setting signal. Thus, the user can control a plurality of OSD objects by inputting only one user setting signal.

The user input unit may receive a user setting signal from a remote control device connected wirelessly or by wire to the image display device. The remote control device may be a pointing device that detects movement of the image display device and transmits a signal including a command corresponding to movement to the image display device.

When the user has input a user setting signal using a remote control device such as a pointing device, the controller 170 may determine that the user setting signal is a setting signal for an OSD object displayed at a position where a pointer or a curser of the pointing device is located. The remote control device interface unit (denoted “140” in FIG. 2) described above may function as a user input unit.

When the user setting signal has been input, the controller 170 may change the perceived depth, the display position, the display state, and/or the like of the OSD object specified by the user setting signal according to setting information included in the user setting signal (S1030).

For example, when the user setting signal specifies the first OSD object and setting information included in the user setting signal indicates an instruction to increase the depth value by 20, the controller 170 may increase the depth value of the first OSD object by 20 to correct setting of the first OSD object or to regenerate a first OSD object. The perceived depth of the OSD object may indicate a protruding or recessed effect of the OSD object expressed by the depth value as described above. This user setting signal for controlling the perceived depth of the OSD object may be referred to as an “OSD depth control signal”.

The OSD object displayed in 3D may include multiple-view images that may be left-eye and right-eye images. To control the perceived depth of the OSD object, the controller 170 may increase or decrease the interval between the left-eye and right-eye images to increase or decrease the depth value. Accordingly, when a perceived depth control signal for the first OSD object is input, the controller 170 may increase or decrease the interval between the left-eye and right-eye images of the first OSD object and then output the first OSD object to the display 180 and, when a perceived depth control signal for the second OSD object is input, the controller 170 may increase or decrease the interval between the left-eye and right-eye images of the second OSD object and then output the second OSD object to the display 180.

The controller 170 may achieve a slope effect of an OSD object not only by adjusting the interval between the left-eye and right-eye images of the OSD object but also by generating various forms of the OSD object. As described above, to achieve a slope effect of an OSD object, the controller 170 may generate an OSD object having a trapezoid or parallelogram form according to a direction in which the OSD object is inclined or rotated and may change the interval between left-eye and right-eye images in the single OSD object. Accordingly, when the user setting signal is a slope control signal for controlling the slope of one of the first OSD object or the second OSD object, the controller 170 may provide a slope effect to the OSD object by changing a shape of the left-eye and right-eye images of the OSD object into a form such as a trapezoid or a parallelogram and also changing an interval between the left-eye and right-eye images.

The display position may be information indicating a position at which the OSD object is displayed on a plane including the display 180 or a plane parallel to the display 180, regardless of the depth value. For example, when the plane including the display 180 is an X-Y plane, the display position of an OSD object may be expressed by X-Y coordinates of the OSD object on the X-Y plane.

Accordingly, when the user setting signal is an OSD control signal for changing the display position of the OSD object, the controller 170 may control the display position by changing coordinates of one or more of the first and second OSD objects specified by the OSD position control signal. From the viewpoint of the user, the first or second OSD object may appear to move as the user inputs the OSD position control signal. This OSD control signal may be referred to as an “OSD position control signal”.

The user setting signal may also be an OSD control signal for changing a display state of the OSD object. The display state of the OSD object may indicate color temperature, transparency, brightness, sharpness, and/or the like of the OSD object. Accordingly, the OSD display control signal may include information indicating a target OSD object and information indicating both which is to be changed from among the color temperature, transparency, brightness, and sharpness values and by how much the value is to be changed. This OSD control signal may be referred to as an “OSD display control signal”.

The display state of the OSD object may be adjusted with reference to the depth value of the OSD object. That is, color temperature, transparency, brightness, and/or sharpness of the OSD object may be adjusted according to a depth value set for the OSD object or according to the perceived depth of the OSD object. For example, when OSD objects are displayed in multiple layers, OSD objects belonging to the same layer or OSD objects having the same depth value have the same color temperature, transparency, brightness, and/or sharpness value.

For example, when OSD objects are displayed in an overlapping manner in a plurality of layers, the controller 170 may set the sharpness of OSD objects, belonging to a layer whose depth value is set high, to be high and set the sharpness of OSD objects, belonging to a layer whose depth value is set low, to be low. The controller 170 may also set the sharpness to be higher as the depth value decreases. The controller 170 may also set the transparency of OSD objects, belonging to a layer whose depth value is set high, and the transparency of OSD objects, belonging to a layer whose depth value is set low, to be different according to the depth value.

FIGS. 11 to 13 illustrate a plurality of OSD objects displayed according to an embodiment of the present invention. Other embodiments and configurations are also within the scope of the present invention.

FIG. 11 illustrates an example where a first OSD object 1110 and a second OSD object 1120 are displayed in different layers.

In the FIG. 11 embodiment, a user setting signal for controlling the first OSD object 1110 may be input. As the user setting signal is input, the controller 170 may increase the depth value of the first OSD object 1110. The controller 170 may also change the display position, the display state, and/or the like of the first OSD object 1110 according to the user setting signal.

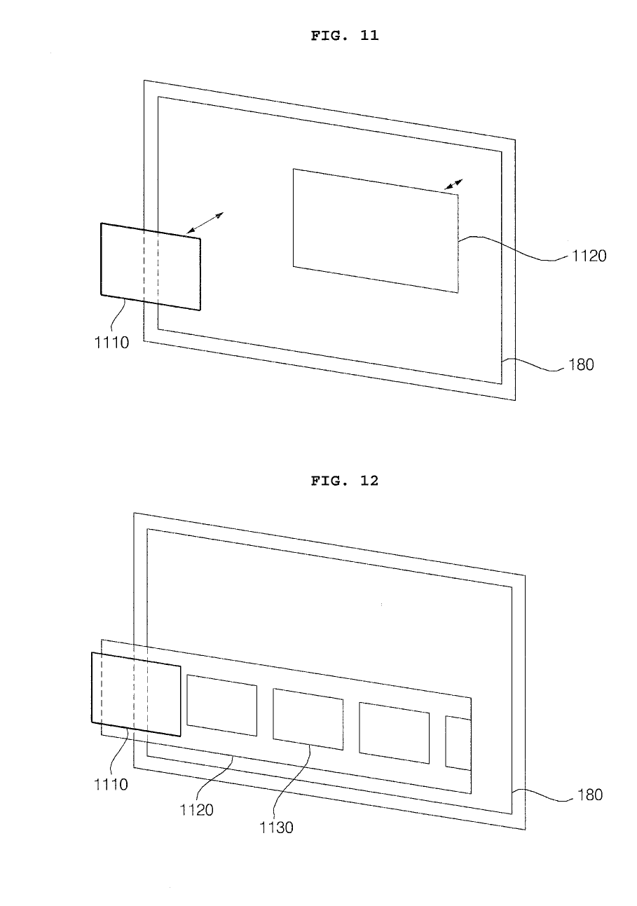

As shown in FIG. 12, the first OSD object 1110, the second OSD object 1120, and a third OSD object 1130 may be displayed with different perceived depths (or apparent depths). In FIG. 12, the second OSD object 1120 corresponds to a single layer and the first OSD object 1110 and the third OSD object 1130 are components of the second OSD object 1120. The second OSD object 1120 may include two or more lower items and the first OSD object 1110 and the third OSD object 1130 are OSD objects corresponding to the lower items. For example, when a specific lower item is selected from the second OSD object 1120, an OSD object corresponding to the lower item may be displayed and the first OSD object 1110 or the third OSD object 1130 may be displayed as the OSD object corresponding to the lower item.

In the FIG. 12 embodiment, a user setting signal for controlling the first OSD object 1110 may be input. As the user setting signal is input, the controller 170 may increase the depth value of the first OSD object 1110. The controller 170 may also change the display position, the display state, and/or the like of the first OSD object 1110 according to the user setting signal.

Although the first OSD object 1110 and the third OSD object 1130 are displayed in the same layer as components included in the second OSD object 1120, the first OSD object 1110 may have a different depth value from other OSD objects in the same layer since the user setting signal is input only for the first OSD object 1110.

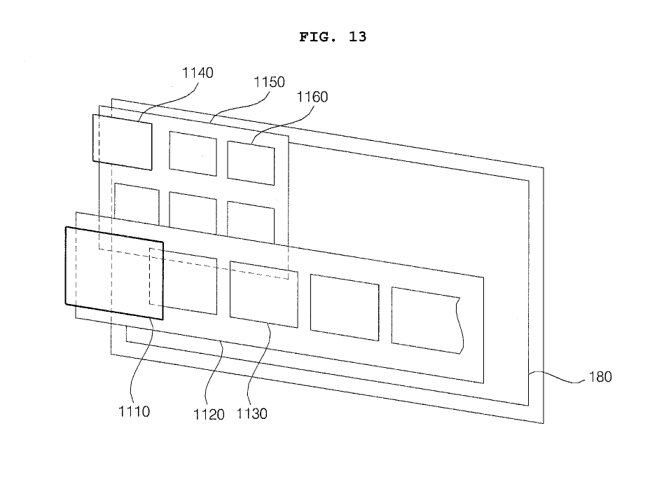

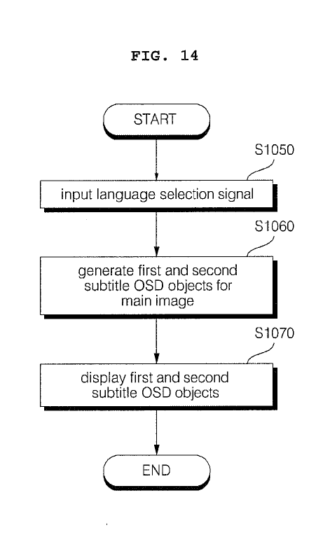

FIG. 13 illustrates an example where first, second and third OSD objects 1110, 1120, and 1130 and fourth, fifth, and sixth OSD objects 1140, 1150, and 1160 are displayed with different apparent depths. The first OSD object 1110 and the third OSD object 1130 are components of the second OSD object 1120 and the fourth OSD object 1140 and the sixth OSD object 1160 are components of the fifth OSD object 1150. The second OSD object 1120 and the fifth OSD object 1150 may correspond to different layers and the first and third OSD objects 1110 and 1130 and the fourth and sixth OSD objects 1160 are components of the different layers.

The first OSD object 1110 and the third OSD object 1130 may correspond to lower items included in the second OSD object 1120 and the fourth OSD object 1140 and the sixth OSD object 1160 may correspond to lower items included in the fifth OSD object 1150. An OSD object as a component or an OSD object corresponding to a lower item of another OSD object may be referred to as a “lower OSD object”.

In FIGS. 12 and 13, the first OSD object 1110 and the third OSD object 1130 may be lower OSD objects than the second OSD object 1120, and the second OSD object 1120 may be a higher OSD object than the first OSD object 1110 and the third OSD object 1130. The fourth OSD object 1140 and the sixth OSD object 1160 may be lower OSD objects than the fifth OSD object 1150, and the fifth OSD object 1150 may be a higher OSD object than the fourth OSD object 1140 and the sixth OSD object 1160.

In the FIG. 13 embodiment, a user setting signal may be input for the first OSD object 1110 and the fourth OSD object 1140. Two user setting signals may be input for the first OSD object 1110 and the fourth OSD object 1140, respectively, and a single user setting signal may also be input for a plurality of OSD objects (i.e., for the first OSD object 1110 and the fourth OSD object 1140).

Accordingly, the perceived depth (or apparent depth), the display position, the display state, and/or the like of the first OSD object 1110 may be set to be different from those of the other OSD objects in the same layer and the perceived depth, the display position, the display state, and/or the like of the fourth OSD object 1140 may be set to be different from those of the other OSD objects in the same layer.

Although the user may input a user setting signal for OSD objects that are components of a layer such as the first OSD object 1110, the third OSD object 1130, the fourth OSD object 1140, and the sixth OSD object 1160, the user may also input a user setting signal for controlling the perceived depth or the like of a layer such as the second OSD object 1120 or the fifth OSD object 1150. When a user setting signal for a layer has been input, an OSD object corresponding to the layer may also be controlled together with components included in the layer or alternatively only the OSD object corresponding to the layer may be controlled regardless of the components included in the layer. That is, when a user setting signal for increasing the perceived depth of the second OSD object 1120 has been input, i) the perceived depths of the first OSD object 1110 and the third OSD object 1130 that are components of the second OSD object 1120 may be equally changed together with the second OSD object 1120 or ii) only the perceived depth of the second OSD object 1120 may be changed while the perceived depths of the first OSD object 1110 and the third OSD object 1130 may be kept unchanged.

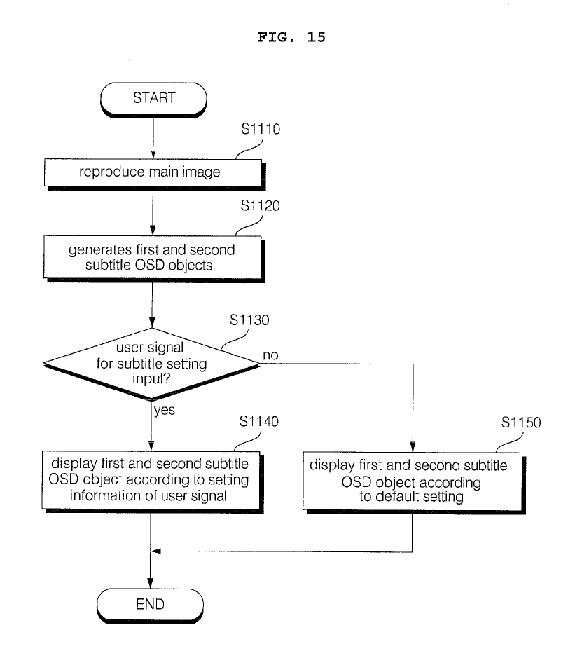

FIG. 14 is a flow chart illustrating a method for operating an image display device according to an example embodiment of the present invention. Other operations, orders of operations and embodiments are also within the scope of the present invention. In the FIG. 14 embodiment, a main image may be reproduced and two or more OSD objects for the main image may be displayed. An OSD object may be used to display a subtitle(s) for a text signal (i.e., written content) or an audio signal corresponding to the main image. A 3D effect may be applied to one or more subtitle OSD objects. The main image may also be displayed as a 3D image.

As the controller 170 reproduces a main image, the display 180 may display a main image. Before and after the main image is displayed, the user input unit may receive a user signal for a subtitle setting (operation S1050). Even when a user signal is not input, the image display device may display a subtitle(s) set by default or a subtitle(s) last stored in the image display device. The FIG. 14 embodiment is described with reference to an example where the user inputs a user signal for a subtitle setting before a subtitle(s) is displayed.

The controller 170 may generate a first subtitle OSD object for displaying a first subtitle(s) for the main image. The controller 170 may then generate a second subtitle OSD object for displaying a second subtitle(s) for the main image (operation S1060). The first subtitle OSD object and/or the second subtitle OSD object may include multiple-view images. Accordingly, the first subtitle OSD object and the second subtitle OSD object may be displayed as OSD objects having different perceived depths (or different apparent depths). If each of the two OSD objects includes multiple-view images, the controller 170 may set the depth values of the two OSD objects to be different by setting a time interval (for example, the time interval between left-eye and right-eye images) of the multiple-view images of each of the OSD objects to be different. Each of the subtitles may include written content regarding the main image.

A language of the first subtitle may be different from a language of the second subtitle. For example, when the user views an English movie, a first subtitle may be a Korean subtitle that is a Korean translation of an English dialogue and a second subtitle may be an English subtitle that directly shows the English dialogue. When the languages of the first and second subtitles are the same, the first and second subtitles may indicate different content. For example, when the main image is a movie, the first subtitle may be a translation of a dialogue of the movie and the second subtitle may be a director or producer's commentary on the movie.

The user may input a language selection signal to select or set a language of the first subtitle OSD object and/or the second subtitle OSD object. The perceived depth (or apparent depth) of each of the first and second OSD objects may increase or decrease depending on the language set for each subtitle.

When a plurality of subtitles are displayed, the controller 170 may set respective positions on the screen, at which the first subtitle OSD object and the second subtitle OSD object are displayed, to be different in order to separately display each subtitle. However, the controller 170 may set the perceived depths (or apparent depths) of the OSD objects of the two subtitles to be different in order to separately display each subtitle. As a result, the perceived depths of the OSD objects of the two subtitles may be set such that a specific subtitle appears to protrude more than (or to be more recessed than) the other subtitle, and the user can select both a subtitle whose perceived depth or depth value is to be set and the perceived depth or depth value of the subtitle.

The perceived depth of each subtitle OSD object may be determined through a depth value setting by the controller 170. When the controller 170 generates a video signal for a subtitle OSD object, the controller 170 may incorporate information regarding the depth value into the video signal. In an example where multiple-view images that constitute the subtitle OSD object are left-eye and right-eye images, an interval between the left-eye and right-eye images set by the controller 170 may be defined as the depth value.

If the types of languages of a first subtitle and a second subtitle are different and the depth value of a subtitle OSD object of each language has been preset, the controller 170 may increase or decrease the depth values of the first subtitle OSD object and the second subtitle OSD object based on types of languages of the first subtitle and the second subtitle. The user may also set the depth value of each language or may change a preset depth value of each language.

The controller 170 may set the respective transparencies of the first subtitle OSD object and the second subtitle OSD object to be different. The transparencies of the OSD objects may increase or decrease according to the depth values of the OSD objects. The controller 170 may increase or decrease transparency of each OSD object as the depth value of the OSD object increases. Accordingly, a user can set the depth value of a subtitle, which they prefer or in which they are interested, to be high or set the transparency thereof to be low, thereby allowing the subtitle to be easily viewed.

The display 180 may display the first subtitle OSD object and the second subtitle OSD object generated and processed through the above procedure (operation S1070). The display 180 may display the second subtitle OSD object as a 3D OSD object using multiple-view images.

FIG. 15 is a flow chart illustrating a method for operating an image display device according to an example embodiment of the present invention. Other operations, orders of operations and embodiments are also within the scope of the present invention.

As shown in FIG. 15, the controller 170 may reproduce a main image and the display 180 may display the main image on the screen (operation S1110). The controller 170 may then generate two or more subtitle OSD objects for the reproduced main image (operation S1120). That is, the controller 170 may generate a first subtitle OSD object and a second subtitle OSD object. The first subtitle OSD object and the second subtitle OSD object may be generated and displayed independently of each other, and a first subtitle and a second subtitle that are displayed through the two subtitle OSD objects may be subtitles in different languages and/or may also be subtitles indicating different content, regardless of the type of the language.

The controller 170 may then determine whether or not a user signal for a subtitle setting has been received from the user through the user input unit (operation S1130). When a user signal for the subtitle setting has been received, the controller 170 and the display 180 may display the first subtitle OSD object and/or the second subtitle OSD object based on setting information included in the user signal (operation S1140).

The user signal may include setting information regarding a method for displaying the first subtitle OSD object and/or the second subtitle OSD object. The setting information may include various information that the user can set in association with a time interval between display of the first subtitle OSD object and display of the second subtitle OSD object, a display position or a perceived (apparent) depth of each subtitle, and/or the like. The user signals including subtitle control items may include a subtitle time difference setting signal, a subtitle display control signal, and/or the like. The term “subtitle time difference setting signal” may refer to a user signal for controlling the time interval between the first subtitle OSD object and the second subtitle OSD object. Additionally, the term “subtitle display control signal” may refer to a signal for controlling various items regarding display states such as a display position, a transparency, a color tone, and/or the like.

The image display device may further include a user input unit for receiving the subtitle time difference setting signal and/or the subtitle display control signal. For example, the remote control device interface 140 may serve as the user input unit when the user inputs the user signal using the remote control device 200 (such as the pointing device 201).

The following description may be provided with reference to an example where a first subtitle OSD object and a second subtitle OSD object are sequentially displayed. This may include an example where the two subtitle OSD objects are not displayed simultaneously but rather are displayed at a time interval therebetween without any limitations as to the order of display of the two subtitle OSD object. In this example, the user signal may be the subtitle time difference setting signal.

For example, the user may set the time interval between the first subtitle OSD object and the second subtitle OSD object to 1 second, 2 seconds, 5 seconds, and/or the like. Alternatively, when the first subtitle OSD object is displayed first, the user may set the second subtitle OSD object to be displayed 1 second ago, 2 seconds ago, and/or the like before a next first subtitle OSD object is displayed. Alternatively, the user may set the time interval to be flexibly adjusted according to a length of a subtitle that is displayed first. According to the subtitle time difference setting signal received through the user input unit, the controller 170 may set the order of display or the time interval of the first and second subtitle OSD objects.

The controller 170 may simultaneously or sequentially output the first subtitle OSD object and the second subtitle OSD object to the display 180, and the display 180 may then sequentially display the first subtitle OSD object and the second subtitle OSD object at the set time interval. That is, the display 180 may immediately display a subtitle OSD object when the controller 170 outputs a video signal according to a subtitle time difference setting signal. Additionally, even when the controller 170 simultaneously outputs video signals associated with a plurality of subtitle OSD objects to the display 180, the display 180 may display the subtitle OSD objects according to a time interval included in a header of each video signal.

A subtitle display control signal for controlling a display state of a subtitle OSD object may also be input through the user input unit. As described above, the display state may be a display position, a perceived (or apparent) depth, a subtitle font size, a subtitle font color, a transparency, and/or the like of the subtitle OSD object. The subtitle display control signal may be a user command or a user signal that the user inputs in order to select, set, and/or change one or more of the display position, the perceived depth, the subtitle font size, the subtitle font color, the transparency, and/or the like of the subtitle OSD object.

The subtitle display control signal may not necessarily be input by the user. For example, a signal that the controller 170 generates according to the overall color tone, color temperature, and/or contrast of a main image in order to correct or reset the color tone, color temperature, transparency, perceived depth, and/or the like of the subtitle OSD object may also be a subtitle display control signal. However, for ease of explanation, the following description may be provided with reference to an example where the user inputs a subtitle display control signal.

The user input unit may receive the subtitle display control signal before or after the controller 170 generates the first subtitle OSD object or the second subtitle OSD object. When the subtitle display control signal is input before the first subtitle OSD object or the second subtitle OSD object is generated, the controller 170 may generate the first subtitle OSD object or the second subtitle OSD object by reflecting control information included in the subtitle display control signal in the subtitle OSD object.

For example, when the user inputs a subtitle display control signal for the second subtitle OSD object, the subtitle display control signal including information for controlling the display state of the second subtitle OSD object, the controller 170 may generate or correct the second subtitle OSD object based on the subtitle display control signal. The control information included in the subtitle display control signal may be information for controlling at least one of the display position, the perceived depth (or apparent depth), and the subtitle font size of the second subtitle OSD object. The subtitle display control signal may further include information for controlling a font size of a subtitle displayed on the second subtitle OSD object, a size of the second subtitle OSD object, a color tone, a sharpness, a contrast, a transparency, and/or the like of the second subtitle OSD object.

Although this embodiment is described with reference to an example where the subtitle display control signal is input for the second subtitle OSD object, this embodiment may be applied not only to the case where the subtitle display control signal is input by the user or is automatically generated by the controller 170 but also to the example where the subtitle display control signal is input for the first subtitle OSD object.

The controller 170 may change the display state of the first subtitle OSD object or the second subtitle OSD object using the subtitle display control signal received from the user input unit and/or may generate a video signal for the corresponding subtitle OSD object based on a display state indicated by the subtitle display control signal.

When a user signal for a subtitle setting is input to the image display device through the above procedure, the controller 170 may process the video signal for the first subtitle OSD object or the second subtitle OSD object based on the user setting and output the processed video signal to the display 180. Upon receiving the video signal, the display 180 may display the first subtitle OSD object and the second subtitle OSD object based on the information set in the subtitle time difference setting signal or the subtitle display control signal (operation S1140).

On the other hand, when a user signal for a subtitle setting is not input within a specific time, the display 180 may display the first subtitle OSD object and the second subtitle OSD object based on a default setting or a last setting stored in the image display device (operation S1150).

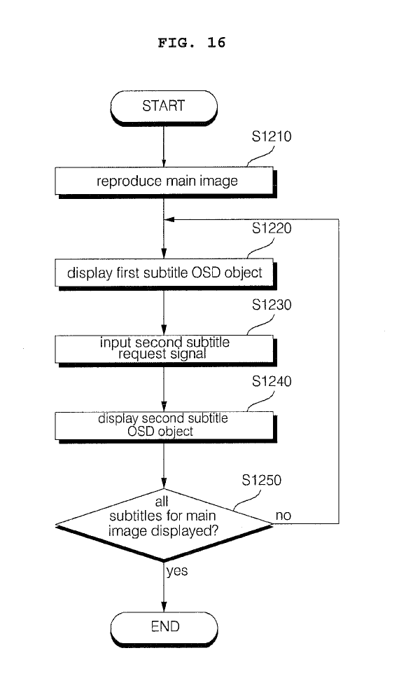

FIG. 16 is a flow chart illustrating a method for operating an image display device according to an example embodiment of the present invention. Other operations, orders of operations and embodiments are also within the scope of the present invention.

FIG. 16 relates to an embodiment where a second subtitle is displayed only when a request signal has been input. Although this embodiment may be included in the embodiment where a plurality of subtitles are sequentially displayed, a time interval between display of the plurality of subtitles may be irregular. When a second subtitle request signal for a current (first) subtitle is not input until a next (first) subtitle is displayed, the second subtitle OSD object may not be displayed, but rather the next subtitle may be displayed.

The controller 170 may reproduce a main image and the display 180 may display the main image on the screen (operation S1210). As the main image is reproduced, the display 180 may display a first subtitle OSD object for the reproduced main image (operation S1220).

The user input unit may receive a second subtitle request signal for displaying a second subtitle OSD object (operation S1230). As the second subtitle request signal is input, the display 180 may display the second subtitle OSD object (operation S1240). That is, the controller 170 may output a video signal for the second subtitle OSD object to the display 180 only when the second subtitle request signal is received within a specific time. Both the first subtitle OSD object and the second subtitle OSD object may be displayed only when the user needs both the first and second subtitles.

The following description is provided with reference to an example where the first subtitle is set in English and the second subtitle is set in French when a user who speaks French and English views an English movie. The user does not input the second subtitle request signal in a scene, content of which is understood using the English subtitle (i.e., the first subtitle) alone. The user may input a subtitle request signal for viewing the French subtitle when the content is not understood using the English subtitle alone. The second subtitle OSD object may be displayed when the user has input the subtitle request signal.

If the first subtitle OSD object or the second subtitle OSD object is displayed only at the request of the user, a number of subtitles may be provided to the user so that the user may more fully enjoy content while reducing complexity of the screen due to display of a plurality of subtitles.

Additionally, when the second subtitle OSD object is displayed as the second subtitle request signal is input, the controller may temporarily stop reproducing the main image. A temporary stop of reproduction of the main image may be selectively applied as a plurality of subtitle OSD objects are displayed.

When the generated subtitle OSD object(s) has been completely displayed as the main image is reproduced, the subtitle display operation of the image display device may also be terminated, for example, when reproduction of the main image is terminated. If part of the main image remains to be reproduced and part of the subtitle OSD object remains to be displayed, the controller may repeat the above operations S1220 to S1240 including displaying the first subtitle, inputting the second subtitle request signal, and displaying the second subtitle OSD object.

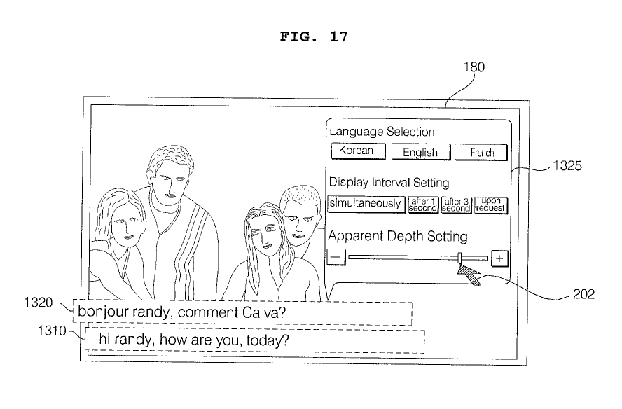

FIG. 17 illustrates two or more subtitle OSD objects displayed on an image display device according to an embodiment of the present invention. Other embodiments and configurations are also within the scope of the present invention.

FIG. 17 illustrates the display 180 on which a main image is being reproduced, a first subtitle OSD object 1310, a second subtitle OSD object 1320, and a subtitle setting window 1325 for controlling the second subtitle OSD object 1320. The language of the first subtitle may be English and the language of the second subtitle may be French.

The user may input a user signal for the second subtitle OSD object 1320. The user signal may be a language selection signal, a subtitle time difference setting signal, a subtitle display control signal, and/or the like as described above. The user may input a language selection signal, a subtitle time difference setting signal, a subtitle display control signal, and/or the like using a pointing device and may input a desired signal by pointing or dragging a specific button displayed on the subtitle setting window 1325 using the pointer 202 of the pointing device.

For example, when a user signal is input with the pointer 202 located on one of “Korean”, “English”, and “French” buttons, a language selection signal for the corresponding language may be input to the image display device. Additionally, when a user signal is input with the pointer 202 located on one of “simultaneously”, “1 second later”, and “3 seconds later” buttons, a subtitle time difference setting signal may be input to the image display device and a time interval between the first subtitle OSD object and the second subtitle OSD object may be set accordingly. If the user clicks an “upon request” button, then the second subtitle OSD object may be displayed only when the user has input a subtitle request signal. The user may set the perceived depth (or apparent depth) by dragging the cursor using the pointer 202 to locate the cursor at a desired position between both depth value limits (−) and (+). In this example, a subtitle display control signal for the perceived depth (or apparent depth) of the first subtitle OSD object or the second subtitle OSD object may be input.

Embodiments of the present invention may have a variety of advantages. For example, a plurality of images or a plurality of objects displayed in multiple layers may be easily identified using perceived depths (or apparent depths) and visual effects that vary depending on the perceived depths (or apparent depths). According to an embodiment, the user may freely set perceived depths (or apparent depths) of images displayed in multiple layers or perceived depths (or apparent depths) of objects that constitute the images. According to an image display device and a method for operating the same, a plurality of subtitles of main images may be simultaneously or sequentially provided to the user. The user may select whether or not to display each of the plurality of subtitles and thus receive a variety of information only when they desire to receive the information. Additionally, when a plurality of subtitles are displayed for one or more main images, the user may easily identify each of the plurality of subtitles without confusion using 3D effects or the like.

The method for operating the image display device may be embodied as processor readable code on a processor readable medium provided in the image display device. The processor readable medium may include any type of storage device that stores data that can be read by a processor. Examples of the processor readable medium may include Read-Only Memory (ROM), Random-Access Memory (RAM), CD-ROMs, magnetic tape, floppy disks, optical data storage devices, and/or so on. The processor readable medium may also be embodied in the form of carrier waves as signals transmitted over the Internet. The processor readable medium may also be distributed over a network of coupled processor systems so that the processor readable code is stored and executed in a distributed fashion.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for operating an image display device to three-dimensionally display an object, the method comprising:
producing a main image;
providing a first subtitle On Screen Display (OSD) object for displaying a first subtitle of the main image;
providing a second subtitle OSD object for displaying a second subtitle of the main image, the second subtitle OSD object having a different depth value from the first subtitle OSD object; and
displaying the first subtitle OSD object and the second subtitle OSD object on the image display device.

2. The method according to claim 1, wherein a content of the first subtitle is different from a content of the second subtitle.

3. The method according to claim 1, wherein a transparency of the displayed first subtitle is different from a transparency of the displayed second subtitle.

4. The method according to claim 1, further comprising receiving a signal for a subtitle setting from a user input.

5. The method according to claim 1, further comprising receiving a signal for specifying a language of one of the subtitles.

6. The method according to claim 1, wherein a language of the second subtitle is different from a language of the first subtitle.

7. The method according to claim 1, wherein the depth values of the first subtitle OSD object and the second subtitle OSD object change based on types of languages of the first subtitle and the second subtitle.

8. The method according to claim 1, wherein when the depth value of the first subtitle OSD object is different from the depth value of the second subtitle OSD object, at least one of a transparency, a sharpness, or a color temperature of the first subtitle OSD object or the second subtitle OSD object changes based on the depth values.

9. The method according to claim 1, further comprising receiving a subtitle time difference setting signal for setting a time interval between displaying of the first subtitle OSD object and displaying of the second subtitle OSD object.

10. The method according to claim 1, further comprising receiving a second subtitle request signal for displaying the second subtitle OSD object,
wherein the second subtitle OSD object is displayed as the second subtitle request signal is input.

11. The method according to claim 1, wherein the second subtitle OSD object includes multiple view objects.

12. A method for operating an image display device, the method comprising:
displaying a first image on the image display device;
receiving an input for a subtitle setting;
displaying a first On Screen Display (OSD) object having a first depth on the image display device, the displayed first OSD object including written content regarding the displayed main image; and
displaying a second OSD object having a second depth on the image display device, the displayed second OSD object including written content regarding the displayed main image.

13. The method according to claim 12, wherein a transparency of the displayed first OSD object is different from a transparency of the displayed second OSD object.

14. The method according to claim 12, further comprising receiving a signal for specifying a language of the written content for one of the displayed first OSD object or the displayed second OSD object.

15. The method according to claim 12, wherein a language of the written content for the first OSD object is different from a language of the written content for the second OSD object.

16. The method according to claim 12, wherein the depth value of the second subtitle OSD object changes based on a type of language of the written content for the second OSD object.

17. The method according to claim 12, wherein when the depth value of the first subtitle OSD object changes, at least one of a transparency, a sharpness, or a color temperature of the displayed first subtitle OSD object and the displayed second subtitle OSD object changes.

18. The method according to claim 12, further comprising receiving a subtitle time difference setting signal for setting a time interval between displaying the first subtitle OSD object and displaying the second subtitle OSD object.

19. An image display device to three-dimensionally display an object, the image display device comprising:
a display for displaying a main image, a first subtitle OSD object and a second OSD object;
a controller for controlling the display to display the first subtitle OSD object for displaying a first subtitle of the main image, and to display a second subtitle OSD object for displaying a second subtitle of the main image, the displayed second subtitle OSD object having a different depth value from the displayed first subtitle OSD object.

20. The image display device according to claim 19, wherein the display displays a transparency of the first subtitle different from a transparency of the second subtitle.

21. The image display device according to claim 19, further comprising a user input for receiving a language selection signal for specifying a language of the subtitles.

22. The image display device according to claim 19, wherein a language of the second subtitle is different from a language of the first subtitle.

23. The image display device according to claim 19, wherein the controller changes the depth values of the displayed first subtitle OSD object and the displayed second subtitle OSD object based on types of languages of the first subtitle and the second subtitle.

24. The image display device according to claim 19, wherein the controller changes at least one of a transparency, a sharpness, or a color temperature of the first subtitle object based on the depth value of the displayed first subtitle OSD object.

25. The image display device according to claim 19, further comprising a user input for receiving a subtitle time difference setting signal for setting a time interval between display of the first subtitle OSD object and display of the second subtitle OSD object.
